(19) United States
(12) Patent Application Publication
(10) Pub. No.: US 2024/0420296 A1
(43) Pub. Date: Dec. 19, 2024

(54) Annotation Based Document Processing with Imperfect Document Images

(71) Applicant: International Business Machines Corporation, Armonk, NY (US)

(72) Inventors: Kai Zhang, Thornhill (CA); Xiaoying Gao, San Jose, CA (US); Rajesh M. Desai, San Jose, CA (US); Sudhakar Basireddy, San Jose, CA (US)

(21) Appl. No.: 18/209,717

(22) Filed: Jun. 14, 2023

(51) Int. Cl. G06T 7/00; G06T 7/73; G06V 10/764; G06V 10/77; G06V 10/774; G06V 30/19; G06V 30/413

(52) U.S. Cl. CPC G06T 7/0002; G06T 7/74; G06V 10/764; G06V 10/7715; G06V 10/774; G06V 30/19013; G06V 30/413; G06T 2207/30168; G06T 2207/30176

(57) ABSTRACT

Mechanisms are provided for automated document image annotation and data extraction. A received document image is processed to identify a document type of the received document image, and retrieve a corresponding document template having key point location data and annotation location data for documents of the document type. First key points of the received document image are matched with second key points of the corresponding document template and a mapping is generated to map locations of the document template to locations of the received document image. A perspective transformation is applied, based on the mapping, to first annotation locations specified in the document template data structure to generate second annotation locations corresponding to locations in the received document image. Data extraction is performed on data associated with the second annotation locations based on the annotations corresponding to the second annotation locations.

### BACKGROUND

The present application relates generally to an improved data processing apparatus and method and more specifically to an improved computing tool and improved computing tool operations/functionality that performs annotation and data extraction processing from document images that have imperfections, such as imprecise document orientations or image quality imperfections.

Being able to extract information from physical documents in an automated and electronic manner has been a focus of technology for some time. For example, initial efforts involved the use of scanners and optical character reading (OCR) to generate digital equivalents to physical documents by capturing images of the text of physical documents and render them as digital textual data. Recently, artificial intelligence (AI) mechanisms have been applied to the extraction of data from documents, such as by extracting structure data, such as tables and forms from documents, as well as unstructured data, such as text, graphics, and the like. These tools are generally based on the capturing of digital images of the physical document and thus, are susceptible to the quality of the digital images captured. This may cause a problem when the image capturing equipment does not capture high quality images, or when the physical document is not perfectly oriented or aligned when the image is captured.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for automated document image annotation and data extraction. The method comprises processing a received document image to identify a document type of the received document image, and retrieving a corresponding document template data structure for the identified document type of the received document image from a document template repository having document templates for a plurality of document types. Each template comprises key point location data and annotation location data for documents of the identified document type. The method further comprises matching first key points of the received document image with second key points of the corresponding document template data structure, and generating a mapping data structure, based on the matching of the first key points with the second key points, to map locations of the document template data structure to locations of the received document image. The method also comprises applying, based on the mapping data structure, a perspective transformation to first annotation locations specified in the document template data structure to generate second annotation locations corresponding to locations in the received document image. Moreover, the method comprises performing a data extraction operation on data associated with the second annotation locations based on the annotations corresponding to the second annotation locations.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1, comprising FIGS. 1A and 1B, presents an example diagram illustrating a problem in document processing with annotation location determinations in view of imperfections in document images;

FIG. 2 is an example diagram of a distributed data processing system environment in which aspects of the illustrative embodiments may be implemented and at least some of the computer code involved in performing the inventive methods may be executed;

FIG. 3 is an example diagram illustrating an automated document processing pipeline in accordance with one illustrative embodiment;

FIG. 4 is an example diagram of the primary operational components of an annotation mapping and data extraction engine in accordance with one illustrative embodiment;

FIG. 5, comprising FIGS. 5A and 5B, presents an example diagram illustrating an operation of the annotation mapping and data extraction engine with regard to example document images;

FIG. 6 is a flowchart outlining an example operation for learning relationships between annotation locations and key points in training document images in accordance with one illustrative embodiment; and

FIG. 7 is a flowchart outlining an example operation for annotating a production document image and extracting data from the production document image in accordance with one illustrative embodiment.

### DETAILED DESCRIPTION

The illustrative embodiments provide an improved computing tool an improved computing tool functionality/operations specifically directed to mapping annotation locations to locations in electronic document images that may have imperfections in the image, and performing data extraction from the electronic document image based on the mapping of annotations to those locations. The illustrative embodiments specifically address the problems in existing automated document processing computing tools with regard to imperfections in the electronic document images and being able to identify annotations for portions of these electronic documents due to the imperfections.

In automated document processing, it is an important task to extract document data from annotations, i.e., metadata, that are associated with portions of that document and describe what that portion of the document represents. This is particularly useful for documents with fixed formats. Given a set of documents, a user provides annotations on areas of the documents on which the user wants to perform data extraction. These annotated documents may then be used as training documents for training an artificial intelligence (AI) computer model to identify portions of a document and annotate those portions of the document with the learned annotations. Thereafter, data extraction from those annotated portions may be performed based on these annotations. Thus, after training the AI computer model, when processing a runtime, or “production document”, the trained AI computer model receives the document image as input and applies the annotations on the document image and thereafter extracts the data (e.g., the text, structured data, images, etc.) from the areas associated by the annotations.

This task of associating annotations with portions of document images becomes challenging when imperfections exist on either the training or the production document images. It is common to have imperfections on scanned document images or those taken from camera devices, such as a smartphone camera, digital camera, or the like, where the physical document may be shifted/partially outside of the image capture area of the device, rotated, skewed, slanted, or the like. In addition, depending on the particular conditions, e.g., lighting conditions, distance to the document, and other conditions, the quality of the features of the captured image of the document, i.e., the document image, may be less than optimal.

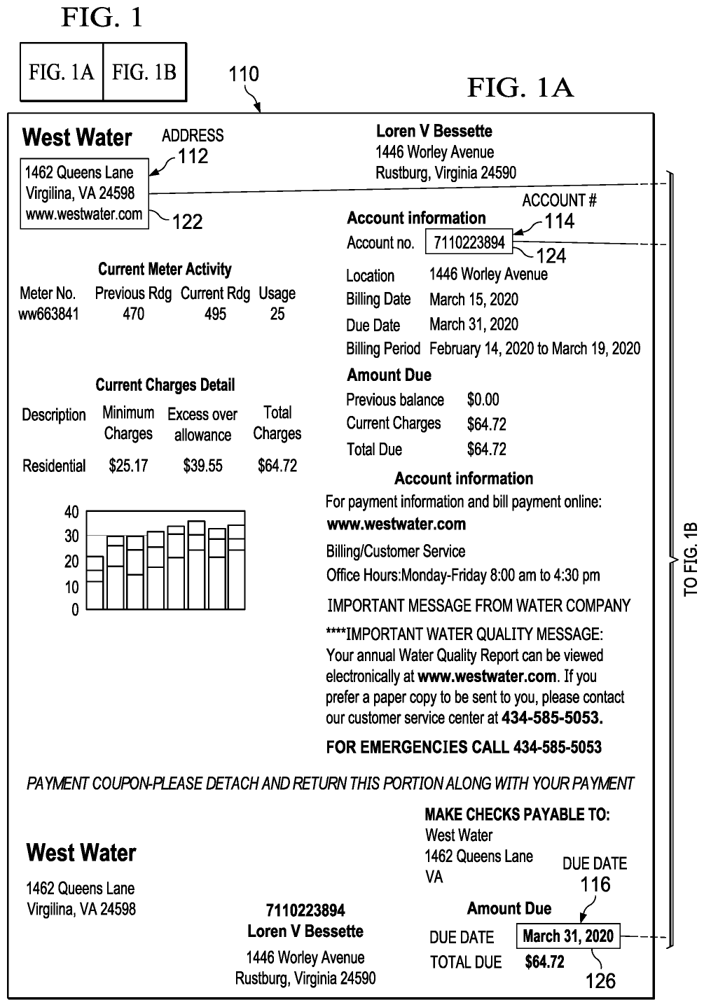

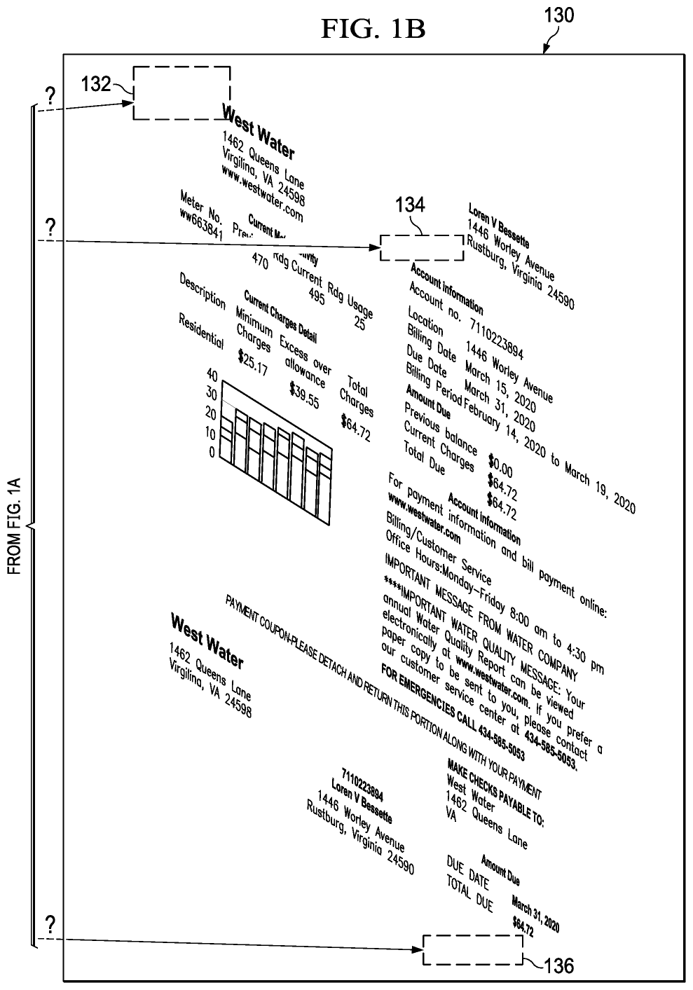

FIG. 1, comprising FIGS. 1A and 1B, presents an example diagram illustrating a problem in document processing with annotation location determinations in view of imperfections in document images. As shown in FIGS. 1A and 1B, a training document image may be a perfectly aligned document image 110 to which corresponding annotations may be applied to various areas of the perfectly aligned document image 110. The application of an annotation, e.g., annotation 112, to an area, e.g., area 122, of the document image 110 associates the metadata of the annotation 112 to the data points of the associated area 122. The term “document image” as used herein refers to an electronic image of a physical document such that the electronic image is represented as a data structure in a data storage and in memory of a computing device.

While the training image provides an association of annotations 112, 114, 116 with points of areas 122, 124, 126 of a training document 110, the same association may not be present in a runtime, or production, document image 130. As shown in FIGS. 1A and 1B, the production document image 130 may have imperfections, which may be due to issues in orientation, alignment, or quality of the image of the physical document that is captured as part of the runtime or production document image 130 creation. That is, the image capture device, e.g., a smartphone, mobile device having a digital camera, or the like, may not be perfectly oriented/aligned with the physical document, may have imperfections in backgrounds of the images, and due to various conditions, may have issues with regard to quality of the image captured, such that imperfections exist in the production document image 130. In the depicted example, the physical document was skewed in orientation relative to the image capture device such that the resulting production document image has the image features skewed relative to a perfectly oriented/aligned document image. Hence, if one were to try to perform a direct mapping of the annotation locations from the training document image 110 to the production document image 130, i.e., assuming the same orientation/alignment of the production document image 130 as the training document image 110, the annotations 112, 114, and 116 may be associated with incorrect areas 132, 134, 136 of the production document image 130. Thus, the data extraction would result in incorrect data being extracted.

Existing automated document processing mechanisms are mainly focused on how to “fix” the image by detecting and correcting the imperfections present in the captured document image individually. For example, in FIGS. 1A and 1B, existing automated document processing would attempt to correct the imperfections in the document image 130 before attempting to perform data extraction from the then corrected document image. However, it is common to have multiple imperfections combined together on the same document image and those individual solutions do not usually generate an acceptable result when presented with multiple imperfections. Moreover, depending on the level of imperfection present, even on individual imperfections, the existing solutions cannot generate good results. Furthermore, if documents have different kinds of backgrounds, it is harder to fix the image.

Rather than attempting to correct imperfections in document images, the illustrative embodiments provide an improved computing tool and improved computing tool functionality/operations that adaptively apply annotations from training document images onto a production document image by learning, through a machine learning process, a mapping of annotation locations from the training document images to locations on production document images even in the presence of imperfections in the training and/or production document images. The illustrative embodiments learn a set of templates for training documents and finds the closest matching template to a production document image. Based on the template, locations of the template are mapped to locations on the production document image and corresponding annotations are applied. Based on the applied annotations, the data from the associated areas of the production document image may then be extracted and used by further downstream computing models, systems, and the like, to perform further automated document processing operations.

In contrast to existing solutions, the illustrative embodiments are able to handle all types, and multiple, document image imperfections at substantially the same time. In addition to orientation or alignment caused imperfections, image quality imperfections, and other geometric/data quality imperfections, the illustrative embodiments also work well on images with complex backgrounds. The illustrative embodiments do not fix or modify the document images. Instead, the illustrative embodiments determine the coordinate mapping relationship between locations on training document images with annotations using image feature detection, such that the learned relationships may be represented in template data structures, or simply “templates” that specify key point locations and annotation locations for documents of a corresponding document type. The templates may then be matched to production document images and homography transformations applied to the annotation locations of the templates and locations on the production document images. This homography transformation allows annotations to be associated with areas of the production document image and then the data associated with those areas extracted and associated with the metadata of the corresponding annotation. That is, the annotation application by the illustrative embodiments enables downstream computer models, computing systems, or processes to extract the text, images, or other data from the annotated areas of the production document image.

In some illustrative embodiments, the improved computing tool components and corresponding improved computing tool functionality/operations are implemented in two primary stages. In a first stage of operation, an integrated computer model is trained to associate document types with templates of learned key point locations and annotation locations of training document images. In this first stage of operation, the annotation coordinates on the training document images are obtained and key points of the training document images are detected using an image feature detector, such as Oriented FAST and Rotated BRIEF (ORB) algorithms, or the like. In some illustrative embodiments, the key points are key points as defined in the open source ORB algorithm. The relationship between the annotation locations and the key points learned over multiple training document images, trains the integrated computer model to associate annotations with points of a document image. This learned association may then be stored as a template, for annotation mapping, in a template repository for later use in processing production document images. This learning may be performed for multiple different types of documents such that a different set of one or more templates may be stored for each document type in a plurality of document types and thus, based on a classification of a document into a document type, the illustrative embodiments are able to retrieve the corresponding set of templates and identify a best template from the set.

In a second stage of operation, the generated integrated computer model is applied adaptively on a production document image. The second stage of operation may include executing the same feature detector, e.g., ORB, used to generate the integrated computer model, on the production document image to extract key points from the production document image. The integrated computer model may further include a document classifier that classifies the production document image into a document type classification and thereby identify the set of previously stored templates for that document type, as learned through the machine learning training of the first stage of operation. From the set of templates, image feature vector matching, and/or textual matching, may be used to select a best, or closest, matching template from the set of templates. The matching key points between the production document image and the key points of the closest matching template may then be determined using a feature matching algorithm, such as Fast Library for Approximate Nearest Neighbors (FLANN), or the like. Based on the results of this matching, a homography transformation matrix is generated from the matching key points. A homography is an isomorphism of projective spaces, induced by an isomorphism of the vector spaces from which the projective spaces derive. It is a bijection that maps lines to lines, and thus a collineation. In image transformations, the homography transformation matrix is a matrix which, when multiplied with a pixel location, gives a new location for that pixel.

The homography matrix represents the coordinates mapping relationship between a point, or pixel, of the closest template, and a corresponding point, or pixel, of the production document image. The homography matrix is used to transform the annotation coordinates from the template to coordinates of the production document image. With the transformed annotation locations on the production document image, the data (e.g., text, images, or the like) from the corresponding annotated areas of the production document image are obtained, e.g., using an optical character reading (OCR) technology for text, image extraction algorithms for non-text content, or the like.

Thus, rather than requiring a fixing or modification of the production document image in order to extract data from the production document image, the illustrative embodiments are able to extract data based on annotations without having to fix or modify the production document image itself. To the contrary, the illustrative embodiments learn relationships between annotation locations and key points of documents to thereby generate templates and then utilizes those templates, and transformations of key points in the templates to key points in the production document image, to apply the annotations from the templates to the production document image. This allows for targeting the now annotated portions of the production document image for data extraction. This is done even if imperfections exist in the training document images and/or the production document images.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an annotation mapping and data extraction engine that operates to learn relationships between annotation locations and key points of documents, and then applying those relationships to production document images to annotate those production document images even in the presence of imperfections in the document images. The improved computing tool implements mechanism and functionality, such as the annotation mapping and data extraction engine, which cannot be practically performed by human beings either outside of, or with the assistance of, a technical environment, such as a mental process or the like. The improved computing tool provides a practical application of the methodology at least in that the improved computing tool is able to annotate production document images even in the presence of image imperfections, such as issues with orientation, alignment, quality, or the like, based on learned relationships between annotation locations and key points of training document images to generate templates whose points may be transformed to points of a production document image to thereby annotate the production document image.

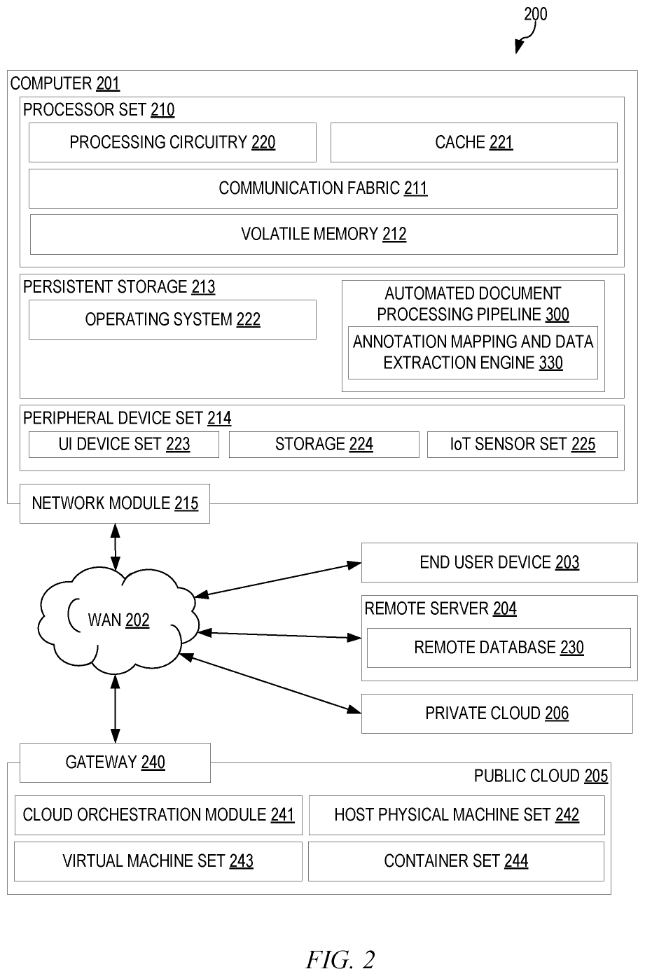

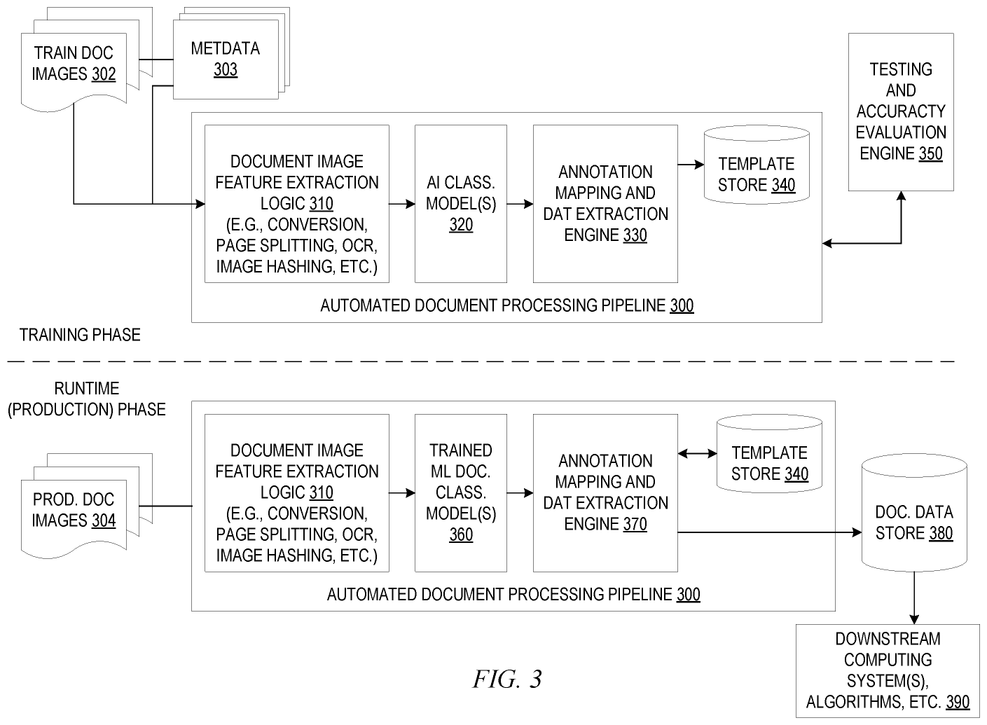

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as annotation mapping and data extraction engine 330, which may be part of an automated document processing pipeline 300, or a separate engine from this pipeline, as described in greater detail hereafter with regard to FIG. 3. In addition to automated document processing pipeline 300 and/or annotation mapping and data extraction engine 330, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and annotation mapping and data extraction engine 300 and/or annotation mapping and data extraction engine 330, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored as automated document processing pipeline 300 and/or annotation mapping and data extraction engine 330 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in the automated document processing pipeline 300 and/or annotation mapping and data extraction engine 330 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement an annotation mapping and data extraction engine 330, which may be part of an automated document processing pipeline 300, for example. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates production document image annotation and data extraction even in the presence of image imperfections. Such results improve the capabilities of automated document processing mechanisms, such as IBM Automation® Document Processing, which is an element of IBM Cloud Pak® for Business Automation, available from International Business Machines (IBM) Corporation of Armonk, New York.

As noted above, in automated document processing, an important task is to extract document data based on annotations associated with documents, where these annotations are metadata that define areas of electronic documents, e.g., electronic images of physical documents, with regard to what the content of those areas represents. For example, if a document is a tax form, and an area stores a social security number of the individual, then an annotation may specify that the particular area of the tax form contains the social security number. This helps with subsequent data extraction mechanisms and downstream processing by extracting data of interest from the annotated areas where such data is present in the electronic document. However, this process becomes challenging when there are imperfections in the electronic documents as there may be a misalignment of the annotations to correct areas of the electronic document, or an inability to determine the proper location of annotations in the electronic document, especially when the electronic document is an image of a physical document, as noted previously with regard to FIGS. 1A and 1B.

FIG. 3 is an example diagram illustrating an automated document processing pipeline in accordance with one illustrative embodiment. The annotation mapping and data extraction mechanisms of the illustrative embodiments may be implemented in the automated document processing pipeline 300, such as in stages 320-330 and 350-360 of the training stage operation and runtime, or production, stage operation, respectively. The training stage operation trains the computer models to learn relationships between annotation locations of training document images and key points of the training document images to generate template data structures. The runtime/production stage operation applies the learned relationships represented in these template data structures, as well as data point transformations, to apply annotations to production document images and extract the corresponding data from the areas that are annotated, to thereby generate extracted data from the production document images that may be stored in a persistent storage for subsequent downstream processing in an automated document processing system.

As shown in FIG. 3, during a training stage of operation, training document images 302 are input to document image feature extraction logic 310 to perform operations to extract features from the training document images 302. For example, operations such as document image conversion, page splitting, optical character reading (OCR), and image hashing may be performed to generate image and/or textual features of the training document image 302. In some illustrative embodiments, this feature extraction may include the feature extraction logic 310 may include ORB algorithms, for example.

The training documents 302 preferably have associated annotation metadata 303 which specifies characteristics of corresponding portions of the training document image 302. For example, the annotations may specify sections or areas of a document, what the content of those sections or areas represent, and other characteristics of the corresponding section/area. For example, annotations may be of the type “Title”, “Summary”, “Abstract”, “Social Security Number”, “First Name”, “Last Name”, “Tax ID”, or any other suitable annotation that connotes meaning to the data present in the corresponding area. These annotations 303 may be associated with areas of the training document images 302 in a manual manner by a subject matter expert manually annotating the training document images 302 by specifying the portion of the training document image 302, e.g., the region of pixels, that annotation 303 corresponds to and which annotation 303 applies. Alternatively, automated annotation mechanisms may also be utilized in addition to, or in replacement of, the manual processes, where these automated annotation mechanisms, for example, may utilize recognizable terms/phrases, formatting data, and the like, to identify corresponding portions of documents and automatically annotate them with corresponding annotations.

The extracted features from the feature extraction logic 310 are input to a classification AI computer model 320 to train the AI computer model 320 to classify document images with regard to a document type, e.g., tax form, credit card application, marriage license, employment verification document, etc. and associate with that classification, a corresponding template data structure that represents a mapping between the annotation location, or coordinates, of the annotations of the training document image, and key points of the document image. The AI computer model 320 is trained through machine learning processes, e.g., linear regression or the like, to learn an association between patterns of input features and corresponding classifications of document images. Moreover, the classifications of document images are correlated with template data structures specifying the relationship between annotation locations and key points in the document images, as learned by the annotation mapping and data extraction engine 330 over multiple training document images 302. It should be appreciated that the key points may be different from the locations of the annotations such that the template data structure maps the relative location of the annotations to the key points, e.g., pixels, in the training document image 302.

The training documents 302 may comprise subsets of training document images of different types, or classifications. The features extracted from training document images 302 of a same subset, may be used to train the AI computer model 320 for classification with regard to that type or classification of document images. Moreover, the locations of annotations in the training document images 302 of the subset, relative to key points identified in the document images 302, may be learned to generate a corresponding template data structure representing the aggregated learning of these relationships in the training documents 302 of the subset. This may be done over multiple subsets to thereby associate classifications of documents by the AI computer model 320, e.g., types of documents, with corresponding template data structures, as learned by the annotation mapping and data extraction engine 330. Thus, a correlation between a pattern of input features, i.e., features extracted from document images 302 by the feature extraction logic 310, and each document type classification and corresponding template data structure may be learned, through machine learning processes. The association of the document image classification with the template data structure may be stored in a template repository 340 for later use in processing production document images during a runtime or production stage of operation. Testing and accuracy evaluations 350 may be performed to ensure proper operation of the trained AI computer model 320 and annotation mapping and data extraction engine 330.

In the runtime, or production, stage of operation, the generated integrated computer models 320 and 330 are applied adaptively on a production document image 304. This second stage of operation may include executing the same feature detection logic 310, e.g., ORB or the like, used to generate the integrated computer model 320, 330, but on the production document image 304 to extract key points from the production document image 304. The features extracted from the production document image 304 during the production stage, are used as input to the trained machine learning document classification model 360 to classify the production document image 304 and retrieve a corresponding template corresponding to that classification, e.g., a tax form or the like, from the template store 340. The annotation mapping and data extraction engine 370, based on the templates, matches key points in the production document image 304 with key points in the retrieved template. This matching of key points between the production document image 304 and the key points of the closest matching template may be determined using a feature matching algorithm, such as Fast Library for Approximate Nearest Neighbors (FLANN), or the like.

Based on the results of this matching, a homography transformation matrix is generated from the matching key points. The homography matrix represents the coordinates mapping relationship between a point, or pixel, of the closest template, and a corresponding point, or pixel, of the production document image. The homography matrix is used to transform the annotation coordinates from the template to coordinates of the production document image 304. With the transformed annotation locations on the production document image 304, the annotation mapping and data extraction engine 370 extracts data (e.g., text, images, or the like) from the corresponding annotated areas of the production document image 304 are obtained, e.g., using an optical character reading (OCR) technology for text, image extraction algorithms for non-text content, or the like. The resulting extracted data is stored in a persistent storage 380 as a representation of the data present in the corresponding production document image 304, where the production document image 304 may be linked to the extracted data in the persistent storage 380. The data in the persistent storage 380 may then be utilized by further downstream computing systems 390, algorithms, users, or the like, to perform additional automated document processing operations.

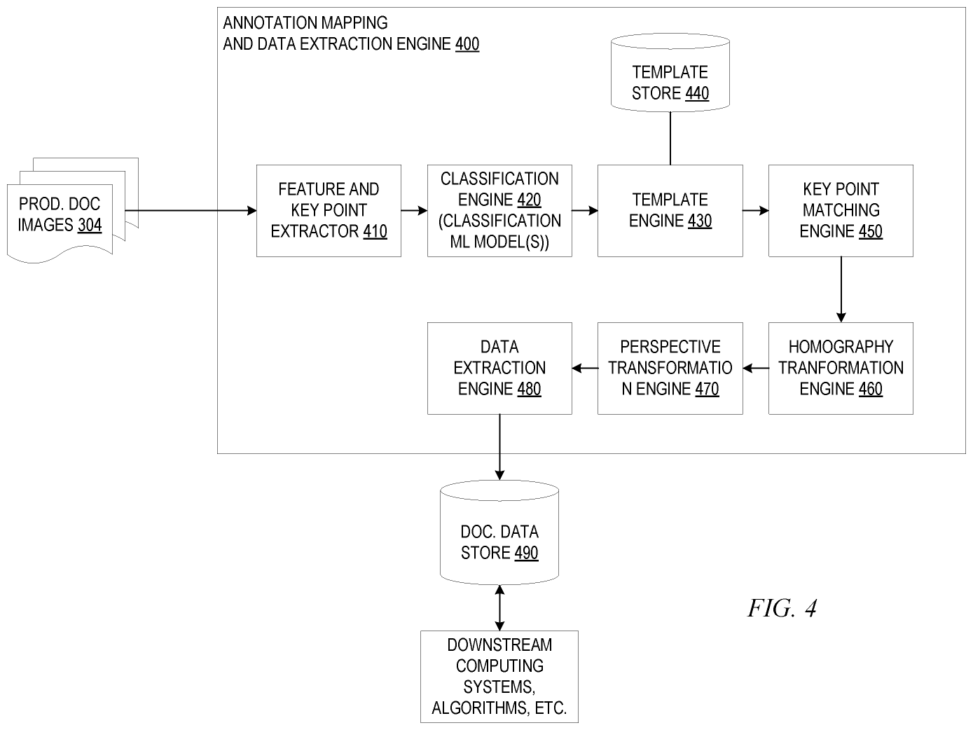

FIG. 4 is an example block diagram of an annotation mapping and data extraction engine in accordance with one illustrative embodiment. The operational components shown in FIG. 4 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., annotations of training document images, and the resulting output may aid human beings, e.g., the extracted data from the automatically annotated production document images. The invention is specifically directed to the automatically operating computer components directed to improving the way that production document image annotation and data extraction are performed, and providing a specific solution that implements learning of relationships between annotation locations and key points, and performing matching of templates and transformation of key points to automatically apply annotations to production document images, which cannot be practically performed by human beings as a mental process and is not directed to organizing any human activity.

As shown in FIG. 4, the annotation mapping and data extraction engine 400 comprises a feature and key point extraction engine 410, a classification engine 420, template engine 430 and corresponding template store 440, a key point matching engine 450, a homography transformation engine 460, a perspective transformation engine 470, a data extraction engine 480, and a document data store 490. These components, or portions thereof, provide a functionality and set of automated computer operations that operate to perform operations during a training phase of operation to learn to classify documents and associate with classifications of documents particular templates of annotation locations and key points within document images. For example, the feature and key point extractor 410 operates on training document images 402 to extract the annotations and their locations, which may be specified in the metadata 403, as well as key points within the document image (as may be determined through one or more key point extraction algorithms), and other features that are descriptive of the document image and/or its content. The extracted features may be input to the classification engine 420 which is trained using a machine learning process to learn associations of patterns of input features extracted from document images, and corresponding classifications of these document images into predefined classifications. The machine learning process may operate to input the training document image 402, have the classification computer model(s) of the classification engine 420 classify the input training document image 402 by determining confidence scores or the like for each predetermined classification and selecting a classification having a highest confidence score. The resulting classification is then compared to a ground truth classification in metadata 403 associated with the training document image 402 to determine an error or loss function value based on who well the confidence score was determined for the classifications. Based on the comparison, a modification of operating parameters, e.g., weights of nodes in the classification computer model(s), may be performed to attempt to reduce the error or loss in the classification computer model(s) output. For example, a linear regression or other machine learning algorithm for modifying operational parameters may be employed. This process may be repeated for multiple epochs and over multiple different training document images.

In addition, the extracted features and key points identified by the feature and key point extractor 410 may be used to build a template for documents of a particular classification. That is, the template engine 430 may analyze the locations of annotations and the key point locations within the document image and store these locations in a template data structure for that classification of document type. These locations may be determined over multiple example training document images from the training dataset 402 that have a same classification of document type, such that the template may represent this aggregate location information and relative positioning of annotations to key points in the document images. For example, the locations and relative position may be an average across the training document images 402 of the same document type. The annotation locations, e.g., coordinates, are specified when the annotations are added to the document image and thus, are present in the metadata 403 of the training document images. The key points in the document image may be determined through any suitable feature extractor, such as Oriented FAST and Rotated Brief (ORB), Scale-Invariant Feature Transform (SIFT) and Speeded Up Robust Features (SURF), or the like.

Thus, during the training of the annotation mapping and data extraction engine 400, the classification computer model(s) of the classification engine 420 are trained and the templates for different document image types are generated. The trained computer model(s) will then be used during runtime, or production, phase operation to classify production document images and identify corresponding templates from the template store 440 that correspond to the production document image's classified document type. That is, during production phase operation, the components of the annotation mapping and data extraction engine 400 operate to map annotations to the production document image, even in cases where the production document image has imperfections in its representation, e.g., misalignments, orientation problems, image quality issues, and the like, without having to fix these imperfections in the production document image before mapping the annotations. Moreover, the mapping of the annotations to the production document image is used as a basis for performing data extraction from the production document image. The extracted data may then be stored in a document data store, i.e., a persistent storage 490, such as in correlation with the production document image or an identifier of the production document image, for later downstream computer operations, such as further automated document processing operations.

For example, assume that a production document image 404 is input to the annotation mapping and data extraction engine 400 during a production phase of operation. The production document image 404 does not have corresponding metadata 403 comprising annotations or ground truth data. The production document image 404 is input to the feature and key point extractor 410 which performs similar operations as during the training phase of operation, to extract key points and other features of the production document image. The features of the production document image are input to the trained classification engine 420 which then generates a classification of document type based on the input pattern of features and the machine learning association of these features with different document types. Thus, at this point in the operation, the annotation mapping and data extraction engine 400 has determine the key points present in the production document image 404 and has determined a classification of a document type of this production document image 404.

The template engine 430 then operates to retrieve a template from the template store 440 that corresponds to the document type determined by the classification engine 420. In some cases, there may be multiple templates provided for each document type. In such a case, all of the templates for the document type may be retrieved and used as potential matches for operation by the key point matching engine 450, for example. In some cases, rather than retrieving all templates for the document type, a closest match may be determined with regard to randomly selected key points and then that closest matching template may be used to perform key point matching as discussed hereafter. In some illustrative embodiments, image features and/or textual features from the production document may be used to generate a feature vector which may then be matched to similar image and/or textual feature based feature vectors for the template data structures to determine a closest match using vector comparisons.

The key point matching engine 450 operates to perform key point matching between the identified key points in the retrieved template(s) and the key points identified by the feature and key point extractor 410 for the current production document image 404. Any suitable feature matching algorithm, such as FLANN, or the like, may be used to perform feature or key point matching. In some cases, a distance metric may be evaluated between key points to determine if a distance between key points is less than a predetermined threshold distance to determine for each key point in the production document image if there is a corresponding key point within the threshold distance in the retrieved template. If so, then it is determined that the key point in the production document image is a matched key point. A threshold number of matched key points may be predetermined such that the production document image is determined to have a matching template only if the threshold number of matched key points is present. If the predetermined number of matched key points is not present for a production document image, then it can be determined that there is no existing template for this production document image and the annotation and data extraction cannot proceed. In some illustrative embodiments, in the case where an existing template cannot be identified, then other existing algorithms may be used to extract the data from the production document image.

In cases where a document type has a plurality of corresponding templates to consider, this process may be repeated for each possible template to determine if one or more of the templates provide a sufficient number of matching key points. If more than one template has a sufficient number of matching key points, then any suitable mechanism for deciding between these templates may be used to identify a single template to use for annotation mapping, e.g., the one with the most matching key points, the one with the highest number of uses, random selection between the possible templates, etc.

Assuming that the predetermined number of matched key points are identified in the production document image, with regard to a retrieved template, the annotation locations in the template, relative to the key point locations in the template, are used to generate a homography transformation matrix 465. That is them homography transformation engine 460 uses the matching key points to generate a homography transformation matrix 465, using a suitable homography transformation algorithm, where this matrix 465 represents the coordinate mapping relationship between the template key points and the key points of the production document image 404. This homography transformation matrix 465 is then utilized by the perspective transformation engine 470 to execute a perspective transformation on the annotation locations, i.e., the coordinates of the annotations in the template, to thereby identify new annotation locations mapped to the production document image. Thus, the key points of the template and production document image are used to determine a matrix 465 that correlates the key points of the template to the corresponding key points of the production document image, which captures the imperfections in the production document image and/or the training documents and compensates for such. This correlation is then used as an assumption that similar correlations of annotation locations will result in proper positioning of the annotations from the template onto the production document image. Hence, these transformations apply the annotations to the proper locations of the product document image 404 where those annotations should be taking into account any imperfections in the production document image 404.

The perspective transformation engine 470 applies the annotations from the template to the production document image 404 using the perspective transformation based on the homography transformation matrix 465 to thereby generate an annotated production document image 475. The annotated production document image 475 is provided to the data extraction engine 480 which operates on the annotated areas of the annotated production document image 475, to extract the data located in these areas. This data extraction may involve any known or later developed document image based data extraction including optical character reading (OCR), image data extraction algorithms, and the like. The resulting extracted data is stored in the document data store 490 in association with the production document image 404 or an identifier or other link to the production document image 404. The document data stored in the document data store 490 may be retrieved and processed by other downstream computing systems, algorithms, or the like, for performance of further operations, such as other automated document processing operations or the like.

For example, if the extracted data is from a credit card application form, the extracted data may be used to trigger credit card approval workflows. Depending on the particular extracted data, the data may trigger automatic approval workflow, an automatic rejection workflow, or a workflow for engaging human review of the credit card application form for approval/rejection. Of course, other types of downstream data processing and automated document processing operations may be implemented and invoked based on the particular document data extracted and stored in the document data store 490, without departing from the spirit and scope of the present invention.

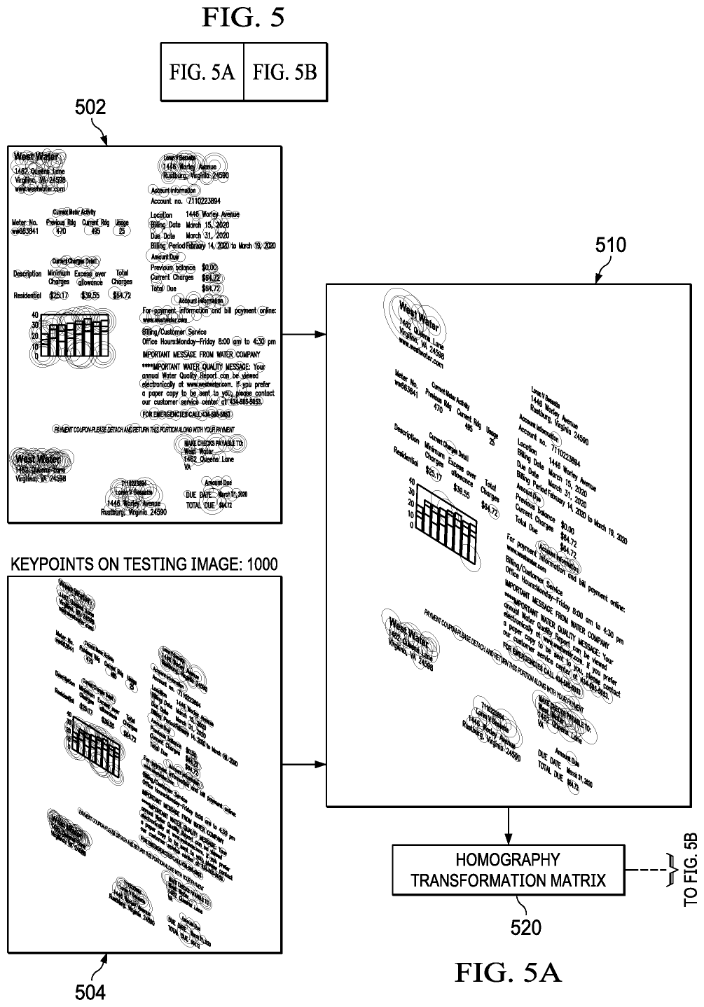

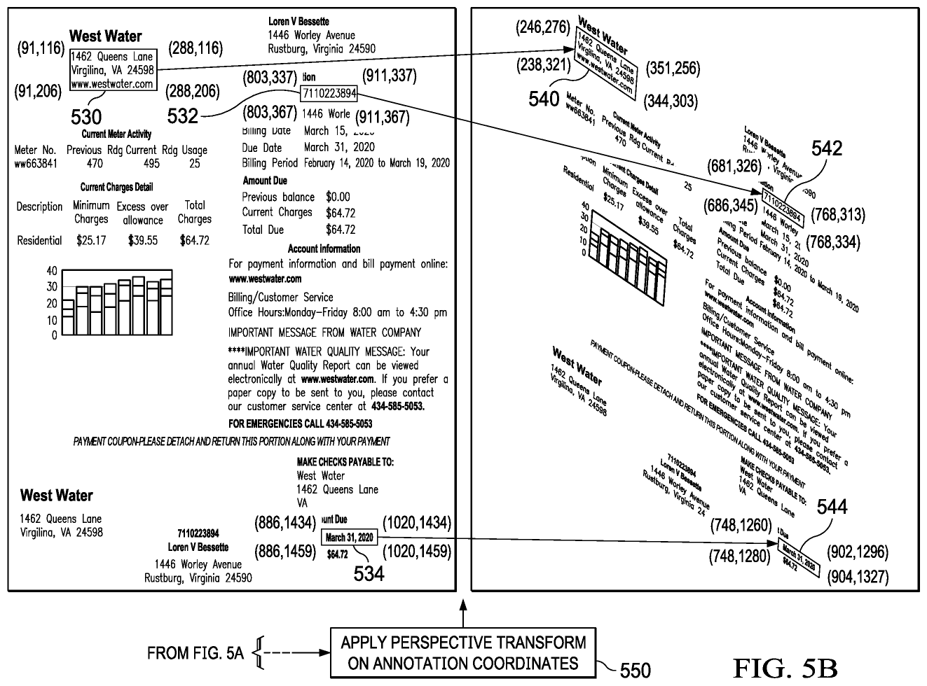

FIG. 5, comprising FIGS. 5A and 5B, presents an example diagram illustrating an operation of the annotation mapping and data extraction engine with regard to example document images. As shown in FIGS. 5A and 5B, a template data structure 502 corresponding to a document type classification for a particular type of document, has various key points identified in the template 502 at various locations (these are shown as the circular elements of 502). These key points may be identified using ORB, SIFT, SURF, or the like, for example. Similarly, a production document image 504 also has the key points identified using similar mechanisms. These key points of the template 502 and the document image 504 are matched through a feature matching algorithm 510, such as FLANN or the like. Based on the matching of the key points a homography transformation matrix 520 is generated that essentially maps the key point locations of the template 502 to the key point locations of the production document image 504. The homography transformation matrix 520 is applied as part of a perspective transformation 550 on the annotation location (coordinates) 530-534 of the template 502 so that the correct locations 540-544 of those annotations are identified in the production document image 504 and thus, the correct data may be extracted from the corresponding areas of the production document image 504 based on the annotations.

For example, in the depiction, a bounding box for a first annotation is shown as annotation location 530, having vertex coordinates (91, 116), (288, 116), (91, 206), and (288, 206). Through the perspective transformations 550 based on the homography transformation matrix 520, this annotation bounding area is transformed into the corresponding coordinates on the production document image as the bounding box 540 having coordinates (246, 276), (351, 256), (238, 321), and (344, 303). Similarly, for bounding area 532, the coordinates are mapped to area 542, i.e., from coordinates (803, 337), (911, 337), (803, 367), and (911, 367) to coordinates (681, 326), (768, 313), (680, 345), and (768, 334). Similar transformations are performed for the other annotation areas. It should be appreciated that while the areas 530-534 are shown as rectangular, the resulting areas 540-554 may be skewed due to the imperfections in orientation, alignment, etc. of the production document image and therefore, are not perfect rectangles and instead are skewed rectangles. Moreover, the areas need not be rectangular or even geometric, and instead may be any suitably specified region for the particular implementation.

Thus, with the mechanisms of the illustrative embodiments, data extraction is made possible from document images that may have imperfections in their representations, e.g., problems with orientation, alignment with image capturing systems, distortions or quality issues, and the like, without having to perform operations to fix those imperfections prior to data extraction. The illustrative embodiments provide automated document processing mechanisms to learn the relationships between locations of annotations of document images and key points in the document images, and uses transformations to apply those annotations to production document images. These annotations now applied to the production document images based on the learned annotation location to key point relationships, are then used to drive data extraction from the areas of the production document image where the annotations are located. Thus, an improved computing tool and improved computing tool functionality/operations are provided for accurate data extraction from production document images is provided that avoids the inaccuracies and resource intensive operations of document image imperfection corrections required in existing mechanisms.

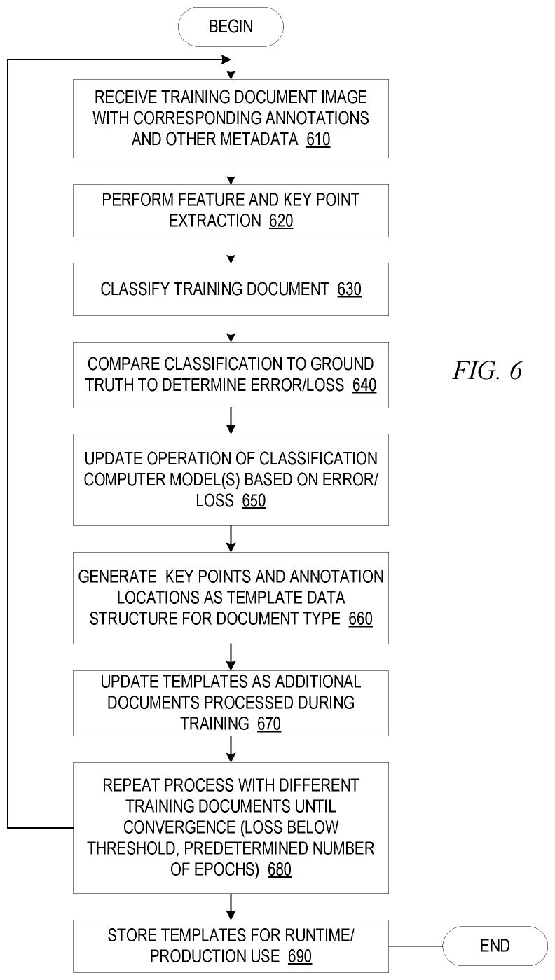

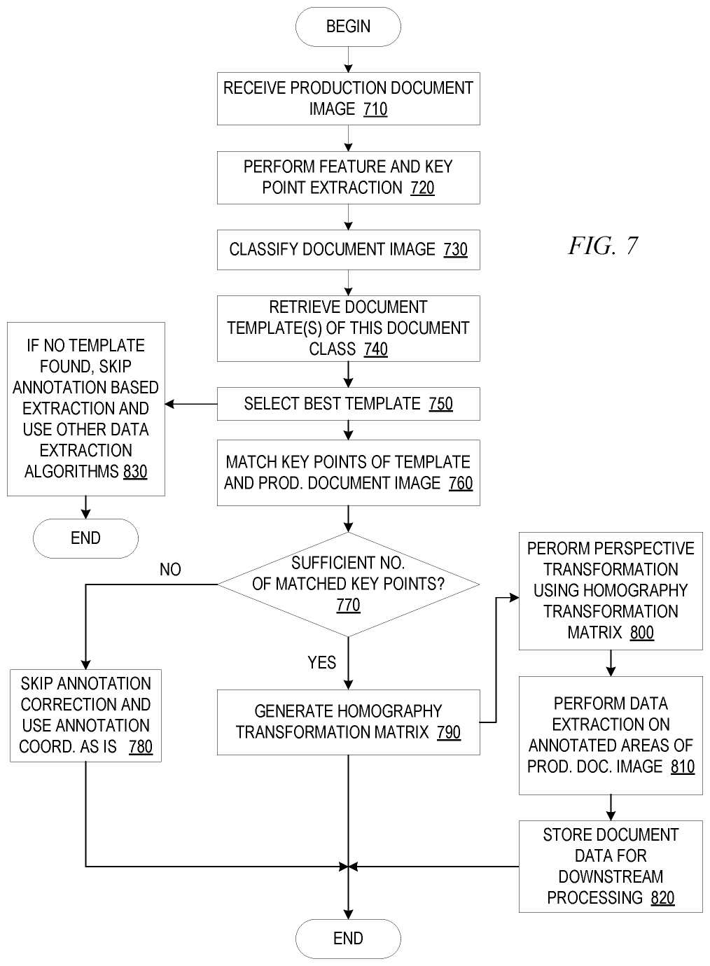

FIGS. 6-7 present flowcharts outlining example operations of elements of the present invention with regard to one or more illustrative embodiments. It should be appreciated that the operations outlined in FIGS. 6-7 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 6-7, and may, in some cases, make use of the results generated as a consequence of the operations set forth in FIGS. 6-7, the operations in FIGS. 6-7 themselves are specifically performed by the improved computing tool in an automated manner.

FIG. 6 is a flowchart outlining an example operation for learning relationships between annotation locations and key points in training document images in accordance with one illustrative embodiment. As shown in FIG. 6, the operation starts by receiving a training document image with corresponding annotations and other metadata, e.g., metadata having ground truth data and annotation data, including annotation location coordinates (step 610). Feature and key point extraction is performed on the training document image to generate document features and key point locations (step 620). The document features, e.g., image features and/or text features, are input to one or more document classification computer models to generate a classification of a document type for the training document (step 630). The classification of the document type is compared to the ground truth document type to determine an error or loss (step 640). The operation of the one or more document classification computer models is then updated, e.g., weights of nodes are modified, to reduce the error/loss of the model(s) (step 650).

In addition, the key point locations and annotation locations for the training document image are maintained as a template data structure (step 660). As new training document images are processed to train the classification computer model(s), the key points and annotation locations of training document images having a same ground truth document type are used to update the template data structure and/or generate a new templated data structure associated with the document type classification (step 670). That is, in some instances, the key point and annotation locations are aggregated across all training document images of the same document type such that a single template data structure is generated for each document type. In other instances, multiple document template data structures may be generated for each document type classification. In generating multiple document template data structures for the same document type classification, some operations may be used to compared the key points of different templates and if the key points sufficiently match in location, e.g., the difference in locations of key points is less than a predetermined threshold, then these templates may be merged into a single template data structure for the document type classification. In this way, the templates may be minimized for each document type classification, while allowing for multiple template data structures for the same document type classification.

This process is repeated with different training document images over time until the error/loss threshold is reached, or the predetermined number of epochs has occurred (step 680). The document template data structures may then be stored for later use in performing automated annotation mapping (step 690). The operation then terminates.

FIG. 7 is a flowchart outlining an example operation for annotating a production document image and extracting data from the production document image in accordance with one illustrative embodiment. As shown in FIG. 7, the operation starts by receiving a production document image (step 710). Feature extraction and key points are identified in the production document image (step 720). The document features, e.g., image features and/or text features, are input to the trained document classification computer model(s) for classification of the production document image into a document type classification (step 730). Based on the document type classification, one or more document template data structures are retrieved from the template store (step 740). A best template is then selected from the retrieved templates (step 750). Key points of the production document image and key points of the one or more document template data structures are matched (step 760).

A determination is made as to whether a sufficient number of matching key points are present between the production document image and at least one of the one or more template data structures (step 770). If there is not a template having a sufficient number of matching key points, then the annotation correction is skipped, and the annotation coordinates are used as is to perform data extraction operations (step 780) and the operation terminates.

If at least one of the template data structures has a sufficient number of matching key points, a homography transformation matrix based on the template key points and key points in the production document image is generated (step 790). The homography transformation matrix is then used to perform a perspective transformation on the annotation location (coordinates) of the annotations in the selected template data structure (step 800). The data in the areas of the annotated production document image are then extracted (step 810) and stored in a document data storage for later downstream processing (step 820). The operation then terminates.

If in step 750 a best template cannot be identified, i.e., there is no template for the document classification, then the annotation based data extraction is skipped and other data extraction algorithms may be utilized (step 830). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for automated document image annotation and data extraction, the method comprising:
processing a received document image to identify a document type of the received document image;
retrieving a corresponding document template data structure for the identified document type of the received document image from a document template repository having document templates for a plurality of document types, wherein each template comprises key point location data and annotation location data for documents of the identified document type;
matching first key points of the received document image with second key points of the corresponding document template data structure;
generating a mapping data structure, based on the matching of the first key points with the second key points, to map locations of the document template data structure to locations of the received document image;
applying, based on the mapping data structure, a perspective transformation to first annotation locations specified in the document template data structure to generate second annotation locations corresponding to locations in the received document image; and
performing a data extraction operation on data associated with the second annotation locations based on the annotations corresponding to the second annotation locations.

2. The method of claim 1, further comprising:
training, via a machine learning process based on a plurality of training document images, a document classification computer model to classify document images into the plurality of document types, and thereby generate a trained document classification computer model; and
generating, for each document type in the plurality of document types, at least one document template data structure specifying key points and annotation locations for document images having the document type, wherein processing the received document image comprises processing the received document image by the trained document classification computer model to identify the identified document type.

3. The method of claim 2, wherein generating at least one document template data structure comprises generating the at least one document template data structure based on a combination of key points and annotation locations for training document images in the plurality of training document images having the document type.

4. The method of claim 2, wherein the training of the document classification computer model comprises:
executing a feature extraction operation on each training document image in the plurality of training document images to generate at least one of image features or text features of the training document image;
processing, by the document classification computer model, the image features or text features of the training document image to generate a predicted classification of the training document image;
comparing the predicted classification of the training document image to a ground truth classification of the training document image; and
modifying an operational parameter of the document classification computer model to reduce a difference between the predicted classification and the ground truth classification.

5. The method of claim 1, wherein the mapping data structure is a homography transformation matrix specifying an isomorphism of projective spaces, wherein the homography transformation matrix, when applied to coordinates of the first annotation locations, generates the second annotation locations.

6. The method of claim 1, wherein the data extraction operation comprises at least one of an optical character reading operation on text content of a second annotation location, or an image extraction algorithm on non-text content of a second annotation location.

7. The method of claim 1, wherein performing the data extraction operation on the data associated with the second annotation locations further comprising storing the extracted data in a persistent storage and accessing the extracted data by a downstream automated document processing computing tool to perform an automated document processing operation.

8. The method of claim 1, wherein retrieving a corresponding document template data structure for the identified document type of the received document image from a document template repository comprises:
retrieving a set of document template data structures associated with the identified document type; and
identifying a closest matching document template data structure from the set of document template data structures, wherein the closest matching document template data structure is retrieved as the corresponding document template data structure.

9. The method of claim 8, wherein the closest matching document template data structure is identified by at least one of matching randomly selected key points of the received document image with key points specified in the document template data structures of the set of document template data structures, or performing a vector comparison of a feature vector of the received document image with a feature vector associated with the document template data structures of the set of document template data structures.

10. The method of claim 1, wherein the received document image comprises at least one geometric or image quality imperfection that causes annotation locations in template data structures for the identified document type to not be aligned with corresponding locations of the received document image.

11. A computer program product comprising a computer readable storage medium having a computer readable program stored therein, wherein the computer readable program, when executed on a data processing system, causes the data processing system to:
process a received document image to identify a document type of the received document image;
retrieve a corresponding document template data structure for the identified document type of the received document image from a document template repository having document templates for a plurality of document types, wherein each template comprises key point location data and annotation location data for documents of the identified document type;
match first key points of the received document image with second key points of the corresponding document template data structure;
generate a mapping data structure, based on the matching of the first key points with the second key points, to map locations of the document template data structure to locations of the received document image;
apply, based on the mapping data structure, a perspective transformation to first annotation locations specified in the document template data structure to generate second annotation locations corresponding to locations in the received document image; and
perform a data extraction operation on data associated with the second annotation locations based on the annotations corresponding to the second annotation locations.

12. The computer program product of claim 11, wherein the computer readable program further causes the data processing system to:
train, via a machine learning process based on a plurality of training document images, a document classification computer model to classify document images into the plurality of document types, and thereby generate a trained document classification computer model; and
generate, for each document type in the plurality of document types, at least one document template data structure specifying key points and annotation locations for document images having the document type, wherein processing the received document image comprises processing the received document image by the trained document classification computer model to identify the identified document type.

13. The computer program product of claim 12, wherein generating at least one document template data structure comprises generating the at least one document template data structure based on a combination of key points and annotation locations for training document images in the plurality of training document images having the document type.

14. The computer program product of claim 12, wherein the training of the document classification computer model comprises:
executing a feature extraction operation on each training document image in the plurality of training document images to generate at least one of image features or text features of the training document image;
processing, by the document classification computer model, the image features or text features of the training document image to generate a predicted classification of the training document image;
comparing the predicted classification of the training document image to a ground truth classification of the training document image; and
modifying an operational parameter of the document classification computer model to reduce a difference between the predicted classification and the ground truth classification.

15. The computer program product of claim 11, wherein the mapping data structure is a homography transformation matrix specifying an isomorphism of projective spaces, wherein the homography transformation matrix, when applied to coordinates of the first annotation locations, generates the second annotation locations.

16. The computer program product of claim 11, wherein the data extraction operation comprises at least one of an optical character reading operation on text content of a second annotation location, or an image extraction algorithm on non-text content of a second annotation location.

17. The computer program product of claim 11, wherein performing the data extraction operation on the data associated with the second annotation locations further comprising storing the extracted data in a persistent storage and accessing the extracted data by a downstream automated document processing computing tool to perform an automated document processing operation.

18. The computer program product of claim 11, wherein retrieving a corresponding document template data structure for the identified document type of the received document image from a document template repository comprises:
retrieving a set of document template data structures associated with the identified document type; and
identifying a closest matching document template data structure from the set of document template data structures, wherein the closest matching document template data structure is retrieved as the corresponding document template data structure.

19. The computer program product of claim 18, wherein the closest matching document template data structure is identified by at least one of matching randomly selected key points of the received document image with key points specified in the document template data structures of the set of document template data structures, or performing a vector comparison of a feature vector of the received document image with a feature vector associated with the document template data structures of the set of document template data structures.

20. An apparatus comprising:
at least one processor; and
at least one memory coupled to the at least one processor, wherein the at least one memory comprises instructions which, when executed by the at least one processor, cause the at least one processor to:
process a received document image to identify a document type of the received document image;
retrieve a corresponding document template data structure for the identified document type of the received document image from a document template repository having document templates for a plurality of document types, wherein each template comprises key point location data and annotation location data for documents of the identified document type;
match first key points of the received document image with second key points of the corresponding document template data structure;
generate a mapping data structure, based on the matching of the first key points with the second key points, to map locations of the document template data structure to locations of the received document image;
apply, based on the mapping data structure, a perspective transformation to first annotation locations specified in the document template data structure to generate second annotation locations corresponding to locations in the received document image; and
perform a data extraction operation on data associated with the second annotation locations based on the annotations corresponding to the second annotation locations.
